(19) United States
(12) Patent Application Publication
(10) Pub. No.: US 2022/0076040 A1
(43) Pub. Date: Mar. 10, 2022

(54) DEVICE AND METHOD FOR DETECTING THE DISTRACTION OF A DRIVER OF A VEHICLE

(71) Applicant: VALEO COMFORT AND DRIVING ASSISTANCE, Créteil (FR)

(72) Inventor: Vincent Delahaye, Creteil (FR)

(73) Assignee: VALEO COMFORT AND DRIVING ASSISTANCE, Créteil (FR)

(21) Appl. No.: 17/299,124

(22) PCT Filed: Oct. 30, 2019
(86) PCT No.: PCT/EP2019/079612

§ 371 Date: Jun. 2, 2021

(30) Foreign Application Priority Data
Dec. 3, 2018 (FR) 1872241

(51) Int. Cl. G06K 9/00; G06T 7/70; B60W 40/08; B60W 50/14; B60W 40/105

(52) U.S. Cl. CPC G06K 9/00845; G06K 9/00355; G06K 9/00375; G06T 7/70; B60W 40/08; B60W 50/14; B60W 2540/229; G06T 2207/30201; G06T 2207/30268; B60W 2040/0818; B60W 2050/143; B60W 2540/223; B60W 2540/225; B60W 40/105

(57) ABSTRACT

A device for detecting the distraction of a driver of a vehicle is disclosed. The device includes an image acquisition assembly to acquire at least one image of a detection area located in said vehicle, said detection area comprising at least part of the driver of the vehicle, a processing module for processing the acquired image, designed to determine: a direction associated with the head of the driver, and a position of at least one hand of the driver, and an analysis module designed to detect the distraction of said driver by determining, on the basis of the direction associated with the head and the position of at least one hand, the possible presence of at least one hand in the direction associated with the head of the driver. A method for detecting the distraction of a driver of a vehicle is also disclosed.

The present invention relates in general to detecting the distraction of an individual, in particular in a vehicle.

It relates more particularly to a device and to a method for detecting the distraction of a driver of a vehicle.

It is known practice to monitor the driver of a motor vehicle using a monitoring device designed to determine a state of alertness of the driver, and in particular to prevent falling asleep at the wheel. Depending on the determined state of alertness, the monitoring device warns the driver so as to prevent him from putting himself in a dangerous situation.

Such a monitoring device deduces the state of alertness of the driver on the basis of behavioral parameters associated with the driver and/or operating parameters of the vehicle. In practice, the behavioral parameters, for example the rate of closure of the eyelids or the gaze direction, are obtained by analyzing images of the head of the driver, and the operating parameters of the vehicle, for example parameters relating to a steering wheel rotation angle, to a speed of the vehicle or to the action of the driver on certain buttons, are obtained from the physical sensors of the vehicle.

Detection systems designed to evaluate the distraction of the driver, for example based on the gaze direction of the driver, are also known. The driver is thus considered not to be distracted when looking at the road or his interior mirror. The driver is considered to be distracted when looking in a direction other than that of the road and the elements necessary for driving, for example at the front passenger.

These systems for detecting the distraction of the driver have the advantage of estimating whether a driver is distracted when a vehicle is operating, and thus considerably improve safety conditions for drivers.

In order to improve systems for detecting the distraction of a driver, the present invention proposes a device for detecting the distraction of a driver of a vehicle.

More specifically, what is proposed according to the invention is a device for detecting the distraction of a driver of a vehicle, comprising:
an image acquisition assembly designed to acquire at least one image of a detection area located in said vehicle, said detection area comprising at least part of the driver of the vehicle,
a processing module for processing the acquired image, designed to determine:

a direction associated with the head of the driver, and

a position of at least one hand of the driver, and
an analysis module designed to detect the distraction of said driver by determining, on the basis of the direction associated with the head and the position of at least one hand, the possible presence of at least one hand in the direction associated with the head of the driver.

The device according to the invention thus makes it possible to determine whether a driver is paying attention to his hand, and therefore possibly to an object that he is holding in his hand and that would possibly compromise his safety by distracting him from the road.

Other non-limiting and advantageous features of the detection device according to the invention, taken individually or in any technically possible combination, are as follows:
provision is also made for a time measurement module designed to evaluate a detection time for which at least one hand is located in said direction associated with the head as determined by the processing module;
provision is also made for an emission module for emitting an alarm signal on the basis of the detection of a distraction situation;
the distraction situation corresponds to a configuration in which at least one hand of the driver is located outside at least one permitted area;
the distraction situation comprises a configuration in which the detection time is greater than a predetermined threshold;
the emission module is designed to emit the alarm signal in the event of a condition of the vehicle being driven;
the driving condition corresponds to the detection of a speed of the vehicle greater than a predetermined speed value or to the lack of use of an autonomous driving unit;
the processing module is also designed to determine a posture of the driver;
the processing module for processing the acquired image is designed to determine the direction associated with the head of the driver and the position of at least one hand of the driver on the basis of a representation of the posture of the driver;
the processing module is designed to determine a direction of orientation of the head of the driver or a gaze direction of the driver.

The invention also proposes a method for detecting the distraction of a driver of a vehicle, comprising steps of:
acquiring at least one image of a detection area located in said vehicle, said detection area comprising at least part of the driver of the vehicle,
determining a direction associated with the head of the driver,
determining a position of at least one hand of the driver, and
detecting the distraction of said driver by comparing the determined direction associated with the head and the determined position of at least one hand so as to determine the possible presence of at least one hand in the direction associated with the head of the driver.

The method may also comprise steps of:
measuring a detection time for which at least one hand is located in said direction associated with the head as determined by a processing module, and
emitting an alarm signal on the basis of the detection of a distraction situation.

The following description with reference to the appended drawings, which are provided as non-limiting examples, will facilitate understanding of the invention and how it may be carried out.

In the appended drawings:

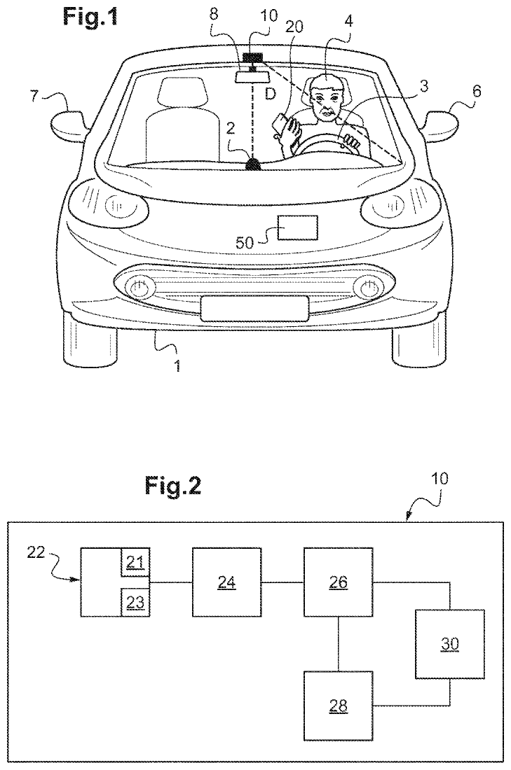

FIG. 1 schematically shows a front view of a motor vehicle equipped with a device for detecting the distraction of a driver according to the invention,

FIG. 2 shows one example of a device for detecting the distraction of a driver according to the invention,

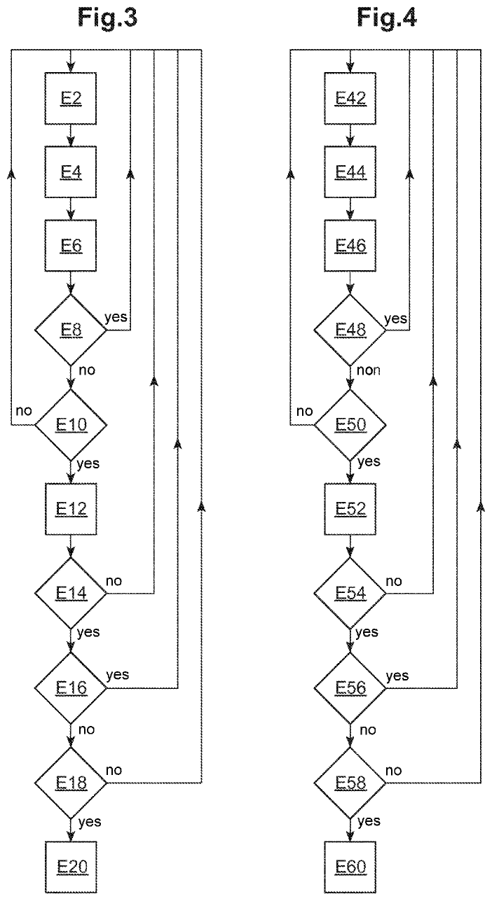

FIG. 3 shows, in the form of a flowchart, a first example of a method for detecting the distraction of a driver according to the invention, and

FIG. 4 shows, in the form of a flowchart, a second example of a method for detecting the distraction of a driver according to the invention.

FIG. 1 shows the front of a motor vehicle 1 (also called “vehicle 1” below) with an on-board device 10 for detecting the distraction of a driver 4 of the vehicle 1.

More precisely, such a distraction detection device 10 is designed to determine the state of distraction of the driver 4 on the basis of determining a posture of the driver 4 in the vehicle 1. The posture thus determined makes it possible to deduce in particular the position of the head and of at least one hand of the driver in order to ascertain whether the driver 4 is concentrating on his driving or, on the contrary, is distracted.

In this description, it is considered that the driver 4 is distracted if he is not focusing his attention on the road or on a mirror (for example a right-hand wing mirror 6 or a left-hand wing mirror 7 or a central mirror 8) or on an element such as a steering wheel 3 or a gear lever 2. On the other hand, the driver 4 is for example considered to be distracted if he is focusing his attention on the front passenger or on an object not useful for driving. For example, in the case shown in FIG. 1, the driver is holding an object 20 in one hand, here a mobile telephone.

As may be seen in FIG. 2, the distraction detection device 10 comprises an image acquisition assembly 22, a processing module 24 for processing at least one acquired image, an analysis module 26, a time measurement module 28 and an emission module 30 for emitting an alarm signal.

The image acquisition assembly 22 is housed on board the vehicle 1, more precisely in the passenger compartment of the vehicle 1. The image acquisition assembly 22 is designed to acquire at least one image inside the vehicle 1.

In particular, the image acquisition assembly 22 is designed to acquire an image of a detection area D located inside the vehicle 1. As shown in FIG. 1, the detection area D extends between the gear lever 2 and the front door of the vehicle 1 (not visible in FIG. 1). This detection area D therefore contains the steering wheel 3 and at least part of the driver 4. In practice, the head and at least one hand of the driver are located in the detection area D.

The image acquisition assembly 22 comprises for example at least one three-dimensional sensor 21 for capturing a three-dimensional image of the detection area D and in particular of the driver 4 of the vehicle 1. As a variant, the image acquisition assembly 22 may also comprise a two-dimensional sensor 23. The two-dimensional sensor 23 is designed for example to capture an image of the face of the driver 4, and in particular of his eyes.

In practice, in order to capture images of the detection area D, the three-dimensional sensor 21 is for example positioned in a front ceiling light of the vehicle 1, such that it acquires a plan view of the detection area D. The two-dimensional sensor 23 is for example arranged in a lower part of the windshield of the vehicle 1, substantially in front of the driver 4.

As a variant, the three-dimensional sensor 21 and two-dimensional sensor 23 may be placed on a dashboard of the vehicle 1, in a central area thereof.

As shown in FIG. 2, the distraction detection device 10 also comprises the processing module 24 for processing the image acquired by the image acquisition assembly 22. The processing module 24 is designed to receive the acquired images and determine a posture of the driver 4 in the vehicle 1.

In particular, the processing module 24 is designed to determine, based on the processing of the acquired images, a representation of the posture of the driver. A representation of the posture of the driver 4 is understood to mean the location and the position of various parts of the body of the driver 4, in particular the head and the hands of the driver 4.

In practice, based on this representation of the posture, the processing module 24 is designed to determine a direction associated with the head of the driver 4. A direction associated with the head is understood here to mean for example an overall direction of orientation of the head or a direction of a part of the head of the driver. In the example described here, the direction associated with the head comprises the direction of orientation of the head or the gaze direction of the driver 4. In particular, the processing module 24 is designed here to determine a direction of orientation of the head of the driver 4. The processing module 24 is also designed to determine the position of at least one hand of the driver 4 on the basis of the representation of the posture. The processing module 24 is also designed to determine a gaze direction of the driver 4 when images are acquired by the two-dimensional sensor 23.

The distraction detection device 10 also comprises the analysis module 26. The analysis module 26 is designed to determine, based on the direction of orientation of the head and the position of the hands as determined by the processing module 24, the possible presence of at least one hand in the direction of orientation of the head of the driver 4. In other words, the analysis module 26 determines whether the head of the driver 4 is directed toward one (or toward both) of his hands. As a variant, the analysis module 26 may determine whether the gaze of the driver 4 is directed toward one of his hands.

As may be seen in FIG. 2, the distraction detection device 10 comprises a time measurement module 28. This time measurement module 28 is designed to evaluate a detection time for which at least one hand is located in the direction of orientation of the head of the driver 4. In other words, the time measurement module 28 evaluates the time (called detection time here) for which the head of the driver 4 remains directed toward at least one of his hands. As a variant, the time measurement module 28 may evaluate the time for which the gaze of the driver remains directed toward at least one of his hands.

Finally, the distraction detection device 10 comprises an emission module 30 for emitting an alarm signal. The emission module 30 for emitting an alarm signal is designed to emit an alarm signal when a distraction situation is detected. A distraction situation is understood to mean for example the location of at least one hand of the driver 4 outside a permitted area (described below) or the measurement of the detection time greater than a predetermined threshold (also described below).

The invention also relates to a method for detecting the distraction of a driver 4 of the vehicle 1 using the detection device 10 described above.

This method may be advantageously used in order for example to determine whether the driver 4 is being distracted by an object that he is holding in one of his hands, for example a mobile telephone.

FIG. 3 shows a first exemplary implementation of a method for detecting the distraction of the driver 4 of the vehicle 1, illustrated in the form of steps.

As shown in FIG. 3, the method starts in step E2. In this step, at least one image of the detection area D is acquired by the three-dimensional sensor 21 of the image acquisition assembly 22. The acquired image contains in particular the head and at least one hand of the driver 4.

In step E4, the image acquired in step E2 is processed by the processing module 24 in order to determine the posture of the driver. In practice, the processing module 24 determines, based on the acquired image (here the three-dimensional image, as indicated above), a representation of the posture of the driver. In other words, the processing module 24 makes it possible to determine the position of various parts of the body of the driver 4, and in particular the position of the head and of at least one hand of the driver 4.

The processing module 24 then determines, based on the representation of the posture of the driver 4 and therefore through analysis of the acquired images, the direction of orientation of his head and the position of at least one of his hands (step E6).

The method then continues in step E8. In this step, the analysis module 26 uses the position of the hands as determined in step E6 in order to ascertain whether the hands are located in at least one permitted area. A permitted area for the position of the hands is defined based on the areas in which the hands are placed while driving a vehicle. For example here, a permitted area may comprise the gear lever 2, the steering wheel 3, elements for adjusting the ventilation in the passenger compartment or any other driving or control element useful to the driver 4 while he is driving. In the example in FIG. 1, the left hand of the driver is positioned on the steering wheel 3 and is therefore located in the permitted area as defined above. By contrast, the right hand is holding a mobile telephone 20 and is not in the permitted area.

In the method according to the invention, if both hands are in the permitted area, the method returns to step E2. If one (or both) of the two hands are located outside the permitted area, the method continues in step E10.

In step E10, the analysis module 26 determines the possible presence of the hand located outside the permitted area in the direction of orientation of the head of the driver 4. In other words, the analysis module 26 determines whether the head of the driver 4 is oriented toward one of his hands.

If the head of the driver 4 is not oriented toward the hand located outside the permitted area, the method returns to step E2.

Otherwise, as may be seen in FIG. 3, the method continues in step E12. In this step, the time measurement module 28 measures the detection time for which the head of the driver 4 remains directed toward his hand, that is to say the time for which the hand is located in the determined direction of orientation.

This detection time is then compared with a predetermined threshold (step E14). This predetermined threshold corresponds for example to a maximum time for which the driver 4 could divert his attention from the road without jeopardizing his safety. In practice, this predetermined threshold here is between 1 second (s) and 3 s, for example of the order of 2 s. This predetermined threshold could for example be dependent on the speed of the vehicle 1.

If the detection time is less than this predetermined threshold, the driver is not considered to be distracted and the method returns to step E2.

By contrast, if the detection time is greater than or equal to the predetermined threshold, the method continues with steps E16 and E18. In these steps, the analysis module 26 determines whether the driver is in a driving condition. In particular, the driver is in a driving condition if an autonomous driving unit 50 is not being used or if the speed of the vehicle 1 is greater than a predetermined speed value.

In step E16, the analysis module checks for example whether the autonomous driving unit 50 is being used. If so, the driver 4 is not considered to be distracted from his driving, since the autonomous driving unit is assisting him. The method then returns to step E2.

If the autonomous driving unit 50 is not being used, the method continues in step E18. In step E18, the speed of the vehicle 1 is compared with the predetermined speed value. The predetermined speed value is for example very low; step E18 then makes it possible to determine whether the vehicle is stationary. If the speed of the vehicle 1 is less than this predetermined value, the driver 4 is not considered to be in a driving condition (and therefore his state of distraction does not need to be checked). The method returns to step

E2.

If the speed of the vehicle 1 is greater than the predetermined value, the driver 4 is considered to be in a driving condition and should not be distracted. An alarm signal is then emitted in step E20 by the emission module 30. The alarm signal emitted following detection of the distraction of the driver 4 is for example specific, in particular more urgent than a conventional alarm signal (such as for example the signal emitted in the event of a low fuel level). The alarm signal emitted in step E20 is for example of the type of signal emitted when the driver has not fastened his seatbelt, that is to say an intermittent signal whose intensity and frequency increase until the seatbelt has been fastened. Here, the intensity and the frequency of the alarm signal could increase until the driver 4 diverts his attention from the object that he is holding in his hand.

FIG. 4 shows a second exemplary implementation of the method for detecting the distraction of a driver 4 of the vehicle 1, illustrated in the form of steps.

As shown in FIG. 4, the method starts in step E42. In this step, at least one image of the detection area is acquired by the three-dimensional sensor 21 of the image acquisition assembly 22. The acquired image contains in particular the head and at least one hand of the driver 4. At the same time, another image is also acquired by the two-dimensional sensor 23 of the image acquisition assembly 22. This other image contains for example the face of the driver 4.

In step E44, the image acquired in step E42 is processed by the processing module 24 in order to determine the posture of the driver (in a manner similar to step E4 described above). In this step E44, the other image is also processed in order to determine a position of the head and a gaze direction of the driver 4 (this gaze direction, as already indicated, being one example of a direction associated with the head of the driver).

At the end of step E44, the processing module 24 has therefore determined the representation of the posture of the driver 4 and his gaze direction.

The processing module 24 then determines, based on the representation of the posture of the driver 4, the position of at least one of his hands (step E46 similar to step E6 described above). As a variant, the direction of orientation of the head of the driver 4 may possibly be determined based on the representation of the posture of the driver 4 in order to be combined with the gaze direction of the driver 4.

The method then continues in step E48. In this step, as in step E8, the analysis module 26 uses the position of the hands as determined in step E46 in order to ascertain whether the hands are located in the permitted area.

In the method according to the invention, if both hands are in the permitted area, the method returns to step E42. If one (or both) of the two hands are located outside the permitted area, the method continues in step E50.

In step E50, the analysis module 26 determines the possible presence of the hand located outside the permitted area in the direction of orientation of the head of the driver 4. In particular, the analysis module 26 determines whether the gaze of the driver 4 is oriented toward one of his hands. This evaluation makes the detection of the distraction of the driver 4 more accurate (in comparison with using the direction of orientation of the head), since determining the gaze detection makes it possible to ascertain where the attention of the driver 4 is actually focused.

If the gaze of the driver 4 is not oriented toward the hand located outside the permitted area, the method returns to step E42.

Otherwise, as may be seen in FIG. 4, the method continues in step E52. As in step E12, the time measurement module 28 measures the detection time for which the head of the driver remains directed toward his hand, that is to say the time for which the hand is located in the determined gaze direction.

This detection time is then compared with a predetermined threshold (step E54).

If the detection time is less than this predetermined threshold, the driver is not considered to be distracted and the method returns to step E42.

By contrast, if the detection time is greater than or equal to the predetermined threshold, the method continues with steps E56 and E58 (similar to steps E16 and E18). In these steps, the analysis module 26 determines whether the driver is in a driving condition. In particular, the driver is in a driving condition if an autonomous driving unit 50 is not being used or if the speed of the vehicle 1 is greater than a predetermined speed value.

In step E56, the analysis module checks for example whether the autonomous driving unit 50 is being used. If so, the driver 4 is not considered to be distracted from his driving, since the autonomous driving unit is assisting him. The method then returns to step E42.

If the autonomous driving unit 50 is not being used, the method continues in step E58. In step E58, the speed of the vehicle 1 is compared with the predetermined speed value. If the speed of the vehicle 1 is less than this predetermined value, the driver 4 is not considered to be in a driving condition (and therefore his state of distraction does not need to be checked). The method returns to step E42.

If the speed of the vehicle 1 is greater than the predetermined value, the driver is considered to be in a driving condition and should not be distracted. Just as in step E20 described above, an alarm signal is then emitted in step E60 by the emission module 30.

1. A device for detecting the distraction of a driver of a vehicle, comprising:
an image acquisition assembly configured to acquire at least one image of a detection area located in said vehicle, said detection area comprising at least part of the driver of the vehicle,
a processing module for processing the acquired image, designed to determine:
a direction associated with the head of the driver, and
a position of at least one hand of the driver, and
an analysis module configured to detect the distraction of said driver by determining, on the basis of the direction associated with the head and the position of at least one hand, the possible presence of at least one hand in the direction associated with the head of the driver.

2. The device as claimed in claim 1, further comprising a time measurement module configured to evaluate a detection time for which at least one hand is located in said direction associated with the head as determined by the processing module.

3. The device as claimed in claim 2, further comprising an emission module for emitting an alarm signal on the basis of the detection of a distraction situation.

4. The device as claimed in claim 3, wherein the distraction situation corresponds to a configuration in which at least one hand of the driver is located outside at least one permitted area.

5. The device as claimed in claim 3, wherein the distraction situation comprises a configuration in which the detection time is greater than a predetermined threshold.

6. The device as claimed in claim 3, wherein the emission module is configured to emit the alarm signal in the event of a condition of the vehicle being driven.

7. The device as claimed in claim 6, wherein the driving condition corresponds to the detection of a speed of the vehicle greater than a predetermined speed value or to the lack of use of an autonomous driving unit.

8. The device as claimed in claim 1, wherein the processing module is also configured to determine a posture of the driver.

9. The device as claimed in claim 8, wherein the processing module for processing the acquired image is configured to determine the direction associated with the head of the driver and the position of at least one hand of the driver on the basis of a representation of the posture of the driver.

10. The device as claimed in claim 1, wherein the processing module is configured to determine a direction of orientation of the head or a gaze direction of the driver.

11. A method for detecting the distraction of a driver of a vehicle, comprising:
acquiring at least one image of a detection area located in said vehicle, said detection area comprising at least part of the driver of the vehicle;
determining a direction associated with the head of the driver;
determining a position of at least one hand of the driver; and
detecting the distraction of said driver by comparing the determined direction associated with the head and the determined position of at least one hand so as to determine the possible presence of at least one hand in the direction associated with the head of the driver.

12. The method as claimed in claim 11, further comprising:
measuring a detection time for which at least one hand is located in said direction associated with the head as determined by a processing module; and
emitting an alarm signal on the basis of the detection of a distraction situation.
